(19) United States
(12) Patent Application Publication
(10) Pub. No.: US 2023/0277981 A1
(43) Pub. Date: Sep. 7, 2023

(54) ENERGY VAPOR EXCHANGER WITH AN INLET VORTEX GENERATOR

(71) Applicant: Palo Alto Research Center Incorporated, Palo Alto, CA (US)

(72) Inventor: Rohan Morajkar, Palo Alto, CA (US)

(21) Appl. No.: 17/684,898

(22) Filed: Mar. 2, 2022

(51) Int. Cl. B01D 53/22; F15D 1/06; F24F 3/14; B01D 53/26; B01D 69/02; B01D 69/04; B01D 71/36; B01D 69/06

(52) U.S. Cl. CPC B01D 53/229; F15D 1/06; F24F 3/1417; B01D 53/263; B01D 53/268; B01D 69/02; B01D 69/04; B01D 71/36; B01D 53/228; B01D 69/06; B01D 2053/223; B01D 2325/38; B01D 2252/10

(57) ABSTRACT

A membrane assembly of an energy and vapor exchanger includes a gas-permeable membrane having a first major surface that faces a gas flow and a second major surface that faces a liquid desiccant flow. An inlet region is proximate an inlet edge of the gas-permeable membrane. The inlet region includes a vortex generator that creates a vortex in the gas flow as it moves from the inlet edge to an outlet edge of the gas-permeable membrane. The vortex enhances mixing of fluids along the gas-permeable membrane.

### STATEMENT REGARDING FEDERALLY SPONSORED RESEARCH OR DEVELOPMENT

This invention was made with government support under contract number DE-EE0009682 awarded by the Department of Energy. The government has certain rights in the invention.

### SUMMARY

The present disclosure is directed to an energy vapor exchanger with an inlet vortex generator. In one embodiment, a membrane assembly of an energy and vapor exchanger includes a gas-permeable membrane having a first major surface that faces an air/gas flow and a second major surface that faces a liquid desiccant flow. An inlet region is proximate an inlet edge of the gas-permeable membrane. The inlet region includes a vortex generator that creates a vortex in the gas flow as it moves from the inlet edge to an outlet edge of the gas-permeable membrane. The vortex enhances mixing of fluids along the gas-permeable membrane.

In another embodiment, a method involves driving a gas flow across a gas-permeable membrane having a first major surface. A liquid desiccant flow is driven across a second major surface of the gas-permeable membrane. Water vapor is transferred through the gas-permeable membrane between the gas flow and the desiccant flow. A vortex is induced in the gas flow by a vortex generator as it moves from an inlet edge to an outlet edge of the gas-permeable membrane. The vortex enhancing mixing of fluids along the gas-permeable membrane.

These and other features and aspects of various embodiments may be understood in view of the following detailed discussion and accompanying drawings.

### BRIEF DESCRIPTION OF THE DRAWINGS

The discussion below makes reference to the following figures, wherein the same reference number may be used to identify the similar/same component in multiple figures. The figures are not necessarily to scale.

FIGS. 1 and 2 are diagrams illustrating flows across a gas-permeable membrane according to an example embodiment;

FIG. 3 is a diagram of a vortex generator according to an example embodiment;

FIG. 4 is a diagram of an energy and vapor exchanger according to an example embodiment;

FIG. 5 is a perspective view of an energy and vapor exchanger according to another example embodiment;

FIG. 6 is a perspective view of an energy and vapor exchanger according to an example embodiment;

FIG. 7 is a close-up cutaway view of a tube of the of the energy and vapor exchanger shown in FIG. 6; and

FIG. 8 is a flowchart of a method according to an example embodiment.

### DETAILED DESCRIPTION

The present disclosure is generally related to heating, ventilation, and air-conditioning (HVAC) systems. In one example embodiment, a gas-to-liquid vapor exchanger includes design features that increase mixing of fluids along a surface of a gas-permeable membrane. This can be used to absorb or desorb water vapor in to or out of a liquid desiccant in order to dehumidify or humidify air. The humidification and dehumidification can be used in HVAC heating and cooling applications.

Air conditioning systems may simultaneously perform two functions: first to dehumidify and second to cool a forced air stream. Commonly used air conditioning systems use vapor compression, which can both dehumidify and cool the incoming air. However, given a humid air stream, vapor compression may rely on cooling the air stream to below its delivery temperature in order to condense the moisture achieve a low relative humidity, then reheating the air to its delivery temperature. This moisture condensation process dramatically increases the energy requirement of air conditioners, especially in humid climates. An alternative dehumidification method, known as liquid desiccant dehumidification, can substantially decrease the energy intensity of air conditioning, and is the subject of the present disclosure.

Removing moisture from air using a liquid desiccant is an energy-efficient alternative to vapor compression, since it minimizes or removes the need for cooling and reheating the air stream. In a liquid desiccant dehumidification system, the humid air exchanges water vapor with the liquid desiccant. For example, gas-to-liquid vapor exchanger may be used to contact humid air and a liquid desiccant. In this scheme, water vapor selectively permeates a membrane, which separates the air stream from the liquid desiccant stream, and transfers heat to the liquid desiccant. Also, as noted above, energy is also exchanged between the gas and liquid stream in either direction as part of the vapor exchange. The term “energy and vapor exchanger” (EAVE) may also be used herein to various types apparatuses having these functions. The moisture transfer rate of a gas-to-liquid vapor exchange dehumidifier is driven by the difference in the vapor pressure on the air/gas flow side and the equilibrium vapor pressure on the liquid desiccant side which is proportional to the corresponding humidity ratios. The air/gas flow layer right next to the membrane is preferentially dried leading to a lower difference in the humidity ratio leading to a lower moisture removal rate. Vortex generator enhanced mixing has an effect of improving the membrane normal gradients of moisture content and temperature. This increases the Sherwood and Nusselt numbers thereby increasing the net mass and heat transfer across the membrane.

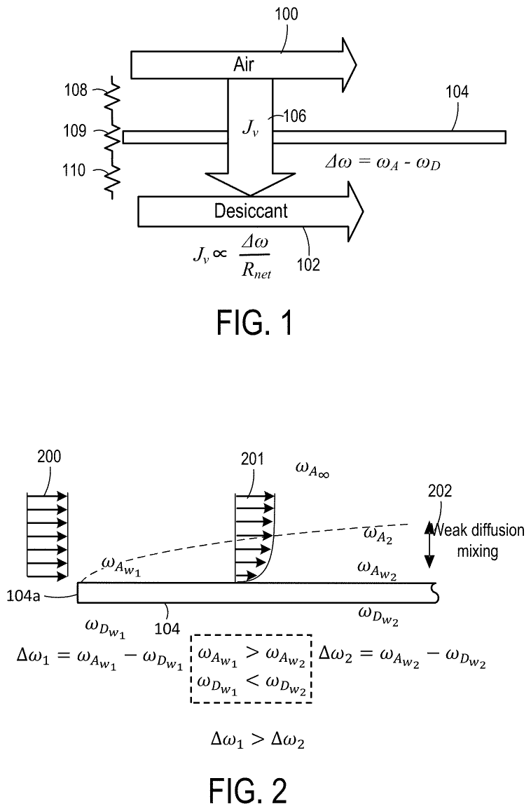

An example of membrane flow is shown in the diagram of FIG. 1. In FIG. 1, an air/gas stream 100 and liquid desiccant stream 102 pass across first and second surfaces of a gas-permeable membrane 104. The membrane 104 may be a hydrophobic membrane formed of expanded polytetrafluoroethylene (EPTFE) in a sheet or tube form, and other gas-permeable materials may be used whether or not they are hydrophobic. The EPTFE may be bonded to a non-porous, plastic support (e.g., polypropylene). The streams 100, 102 may flow in other directions than shown (e.g., opposed to one another or cross flow) and the concepts may be applicable to other gases and liquids besides air and liquid desiccant. Arrow 106 represents a transfer of mass (Jr) across the membrane 104, which includes water vapor ion this example. The opposition to mass transfer is represented by resistances 108-110, in which resistance 108 is advection/diffusion resistance of the air/gas flow 100, resistance 109 is membrane mass transfer resistance, and resistance 110 is advection/diffusion resistance of the desiccant flow 102. The sum of these resistances 108-110 is indicated in the figure as Rₙₑₜ, and the humidity ratios of the air and desiccant flows are ω_{A} and ω_{D} respectively. The mass transfer increases with higher Δω and decreases with higher Rₙₑₜ. Increasing increases efficiency of the gas-to-liquid vapor exchanger.

As seen in the diagram of FIG. 2, an air/gas flow that starts with a uniform velocity profile 200 near an inlet edge 104a of the membrane 104 may assume a laminar velocity profile 201 away from the inlet edge 104a of the membrane 104. As the moisture is exchanged between the air and desiccant streams near the membrane, Aw tends to reduce in the flow direction, while the bulk flow away from membrane retains higher humidity ratios. This results in a region 202 of weak diffusion mixing near the surface of the membrane 104 away from the inlet edge 104a. A turbulent profile may also have a region of weak diffusion mixing, although will be much smaller in dimension normal to the surface of the membrane 104. As indicated in the figure, this results in lower vapor transfer away from the leading edge due to Δω₁>Δω₂.

A laminar flow is typically defined as having a Reynolds number (Re) less than about 2000 for flow in a pipe, although this can vary depending on the shape of the flow path, the length of the flow path, etc. For some flows with a laminar Re near the high end of the range, the flow may start out laminar but transition to turbulent flow away from the inlet edge. In such a case, the having vortex generators at the inlet provide a mechanism to break the flow laminae and allow for convection of a flow of higher moisture content air away from the membrane to near the membrane. For flow in a pipe, turbulent flow begins around Re>3000, although this can vary as well. Note that even if the flow in an energy and vapor exchanger is in the turbulent region, a vortex generator can still help in mixing and may be included.

Some EAVEs feature rectangular channels to constrain the air close to the membrane. These embodiments may make use of a grid or protrusions from the channel wall to generate random turbulence in the air/gas flow stream, thereby increasing mixing of air downstream of the inlet. However, these mixing features also create restrictions in the channel, which increases airflow the pressure differential between the inlet and outlet ports. Embodiments described herein use vortex generators at the inlet to the channel, which leads to a structured streamwise oriented vortex pairs that enhance mixing of moisture laden air away from the membrane with the air/gas flows next to the membrane with relatively lower moisture content. This facilitates convectively replacing gas/air that has dried out near the gas-permeable membrane with wetter air/gas from the air/gas flow.

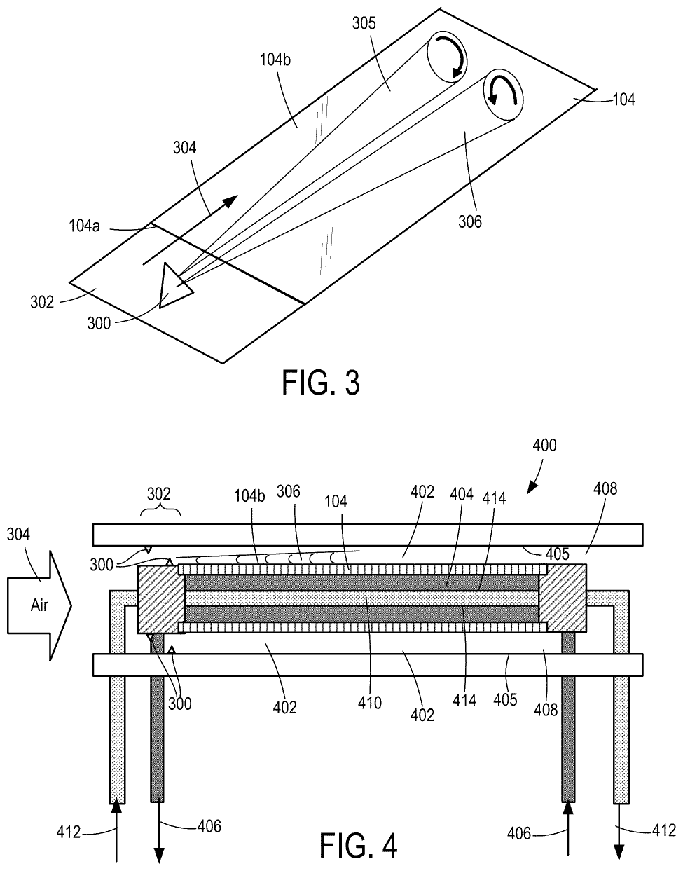

In FIG. 3, a diagram shows a vortex generator 300 according to an example embodiment. The vortex generator 300 is placed on an inlet region 302 which is proximate an inlet edge 104a of the gas-permeable membrane 104. Seen in this view is a first major surface 104b of the membrane 104 that faces an air/gas flow 304. A second major surface (not shown) of the membrane 104 opposes the first major surface 104b and faces a liquid desiccant flow (not shown). As seen here, the vortex generator 300 may create counter-rotating vortex pairs 305, 306 in the air/gas flow 304, although a single vortex or co-rotating vortex pairs may be generated in addition to or instead of the counter-rotating vortex pairs 305, 306. The vortices enhancing mix of fluids along the gas-permeable membrane 104, which can allow an effective flow area of the membrane 104 to be reduced for a given performance point. The vortex generator 300 may be a constant thickness fin, or may have a three-dimensional structure (e.g., pyramidal, triangular prism, dimple, step, etc.) that protrudes into or from the inlet region 302.

In FIG. 4, a diagram illustrates features of an energy and vapor exchanger 400 according to an example embodiment. A air/gas flow path 402 is formed by a gas-permeable membrane 104 having a first major surface 104b that faces an air/gas flow 304. A desiccant fluid flow path 404 is formed at least in part by a second major surface 104c of the gas-permeable membrane. A liquid desiccant 406 moves through the flow path 404. The membrane 104 transfers moisture (water vapor) between the air/gas flow path 402 and the fluid flow path 404, and the transfer may occur in either direction.

An inlet region 302 of the air/gas flow path 402 includes one or more vortex generators 300 protruding from the air/gas flow path 402 that create a vortex 306 in the air/gas flow 304 as the air moves from the inlet to an outlet 408 of the air/gas flow path 402. The vortex 306 increases a transfer of water vapor through the membrane by bringing air characterized by higher/lower humidity ratio away from the membrane in contact with the membrane thereby increasing the Δω. Note that more than one vortex generator 300 may be included in a single air/gas flow path 402 and may be on different surfaces within the inlet region 302. These additional vortex generators 300 may increase mixing throughout the air/gas flow path 402, e.g., moving air near a wall or plate 405 that faces the membrane surface 104b and forms part of the air/gas flow path 402. The vortex generators 300 are located away from the membrane sheet 104 and the plate 405 so as not to obstruct flow within the air/gas flow path 402 downstream of the inlet region 302.

The energy and vapor exchanger 400 also includes a coolant flow path 410 that moves a coolant 412 (e.g., water, glycerol, ethylene glycol, propylene glycol, or combinations thereof) that transfers heat to or from the liquid desiccant 406. Heat transfer walls 414 separate the coolant 412 from the liquid desiccant 406, and are typically formed of a material with good heat transfer conductivity as well as resistance to corrosion from contact with the coolant and liquid desiccant (e.g., a thin heat conducting plastic, titanium, stainless steel or some other convenient corrosion resistant material). As shown, the energy and vapor exchanger 400 may contain a plurality of air paths 402. A plurality of desiccant flow paths 404 and coolant flow paths 410 may also be provided, e.g., by stacking multiple plates that define the various paths.

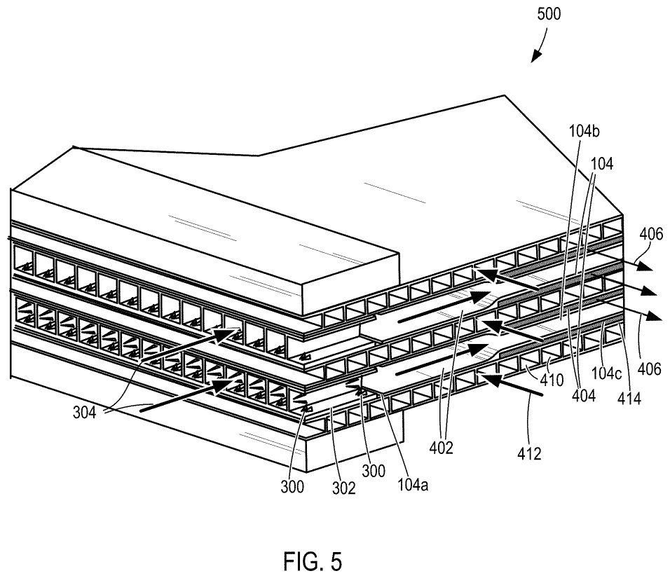

In FIG. 5, a perspective view shows an energy and vapor exchanger 500 according to another example embodiment. Air/gas flow paths 402 are formed by gas-permeable membranes 104 having a first major surface 104b that faces an air/gas flow 304. A desiccant fluid flow path 404 is formed at least in part by a second major surface 104c of the gas-permeable membrane 104. A liquid desiccant 406 moves through the flow path 404. The membrane 104 transfers moisture (water vapor) between the air/gas flow path 402 and the fluid flow path 404, and the transfer may occur in either direction.

An inlet region 302 of the air/gas flow path 402 includes one or more vortex generators 300 that protrude into the inlet regions 302 and create a vortex in the air/gas flow 304 as the air moves from the inlet to an outlet (not shown) of the air/gas flow path 402. The vortex increases a transfer of water vapor through the membrane. While only vortex generator 300 may be used on a single surface of the inlet region 302 (as seen on upper air/gas flow path 402), more than one vortex generator 300 may be included as seen on lower air/gas flow path 402 and may be on different surfaces within the inlet region 302. In this case, the vortex generators 300 are shown at different distances from an inlet edge 104a of the membrane. These additional generators may increase mixing throughout the air/gas flow path 402.

In this embodiment, the inlet region 302 includes a planar structure parallel to and aligned with the gas-permeable membrane 104. The inlet region 302 also includes two other surfaces normal to the first major surface 104b of the gas-permeable membrane 104, and a surface parallel to and separated from the gas-permeable membrane 104. The vortex generators 300 can be placed on any of these surfaces, or any combination of surfaces. The vortex generators 300 could also connect to surfaces, e.g., connecting two opposing parallel surfaces.

The energy and vapor exchanger 500 also includes a coolant flow path 410 that moves a coolant 412 (e.g., water, glycerol, ethylene glycol, propylene glycol, or combinations thereof) that transfers heat to or from the liquid desiccant 406. A heat transfer wall 414 separates the coolant 412 from the liquid desiccant 406, and typically formed of a material with good heat transfer conductivity as well as resistance to corrosion from contact with the coolant and liquid desiccant (e.g., high heat transfer plastics or titanium or any other non-corrosive materials). As shown, the energy and vapor exchanger 400 may contain a plurality of air paths 402, desiccant flow paths 404, and coolant flow paths 410 by stacking multiple plates that define the various paths.

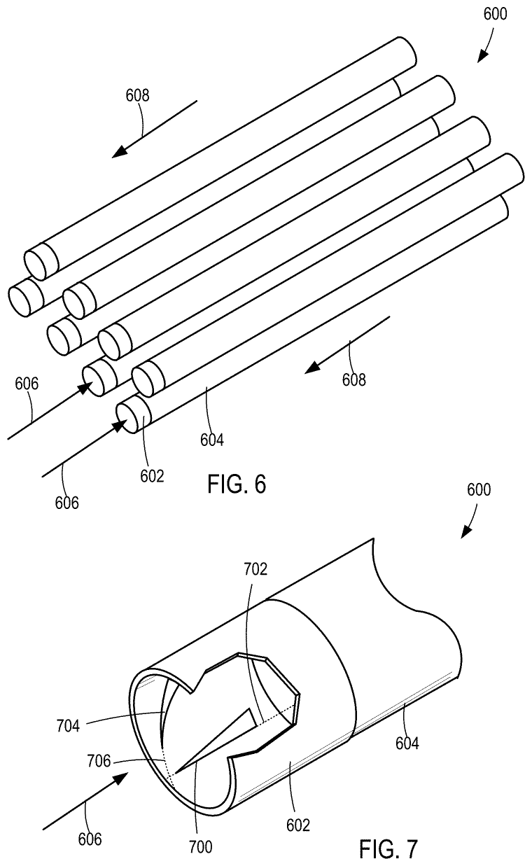

Although the embodiment shown in FIG. 5 uses stacked plate-like structures to form the flow channels, other types of structures may be used to form air and fluid paths. For example, in FIG. 6, a series of tubes 600 is shown that may be used in an energy and vapor exchanger according to an example embodiment. Each of the tubes 600 has a inlet region 602 and a vapor transfer region 604 that includes a gas-permeable membrane. The vapor transfer region 604 may be formed from just a membrane material in tubular shape or may be a composite structure with a membrane material and other sub-structures for support to form flow channels.

A first fluid flow 606 flows through a bore of the tubes 600 and a second fluid flow 608 flows outside of the tubes 600. One of the flows 606, 608 is air and the other is liquid desiccant. The inlet regions 602 may include vortex generators on an inward facing surface or outward facing surface depending on which of the flows 606, 608 is the air/gas flow. While no coolant flow path is shown in FIG. 6, this configuration can be adapted to include a coolant. For example, a housing can encase the tubes 600 to form a path for second fluid flow 608 (which may be liquid desiccant in this case) and this housing can be cooled by a flow of coolant over the housing. If the first flow 606 is liquid desiccant, then a coolant flow path may be made through the bore of the tubes, e.g., using a smaller diameter tube that pass through each tube 600.

In FIG. 7, a close-up cutaway view shows an inlet region 602 in which the internal, first fluid flow 606 is air. A vortex generator 700 is at the inlet region 602 is oriented in a direction 702 that is parallel to a longitudinal axis of the tube 600. A number of these vortex generators 700 may be distributed around the interior of the inlet region 602.

Another vortex generator/swirl vane 704 is also shown, this one following a spiral path 706 along the inside of the inlet region 602. One or more of this type of vortex generator 704 could distributed around the inner surface of the inlet region 602, and may be combined with other types of generators such as vortex generator 700. If the airflow is outside of the tube, then these vortex generators 700, 704 may be place on an outer surface of the inlet region 602.

Targeted introduction of streamwise oriented vortices provides a continuous mixing mechanism for moisture contained air through the channel and can improve the efficiency of the indirect moisture exchangers. This can reduce the area of membrane needed thereby keeping the costs and volume down. This can also potentially reduce the concentration of desiccant required compared to the case without the mixing vortex generators thereby improving overall system efficiency.

The vortex generators can be molded, welded, bolted or epoxied into a plastic or metal that makes up the exchanger part. In other embodiments, the parts can be made by additive manufacturing (e.g., three-dimensional printing), machining, stamping, and/or using adhesives to assemble vortex generators to a surface of a frame or end fitting of the abut an inlet edge of the gas-permeable membrane, forming a membrane assembly that may be an integral part that is replaceable as a unit. In some embodiments, the membrane assembly may include vortex generators on an outlet region, e.g., to allow for reversing the flow during an operational mode, mistake-proofing the assembly process, etc.

In some embodiments, the liquid desiccant comprises a lithium salt (e.g., LiCl, LiBr), other salt (e.g., MgCl₂, CaCl₂)), or combinations thereof, dissolved in water. In some embodiments, the coolant comprises glycerol, ethylene glycol, propylene glycol, or combinations thereof. In some embodiments, the gas-permeable membrane includes polymers such as poly(tetrafluoroethylene), polypropylene, polystyrene polymers, ether polymers, fluorocarbon polymers, poly(vinyl chloride) polymers, or poly(N-vinylpyrrolidone) polymers. In other embodiments, the membrane can be a hydrophilic polymer such as poly(vinyl alcohol), poly(acrylic acid), polyethylene imine), poly(sodium 4-styrene sulfonate), or Nafion. The membrane allows for water vapor permeation, but disallows liquid water or liquid desiccant permeation. The selective permeation of water vapor through the wall of the membrane allows mass and energy exchange without fluid mixing.

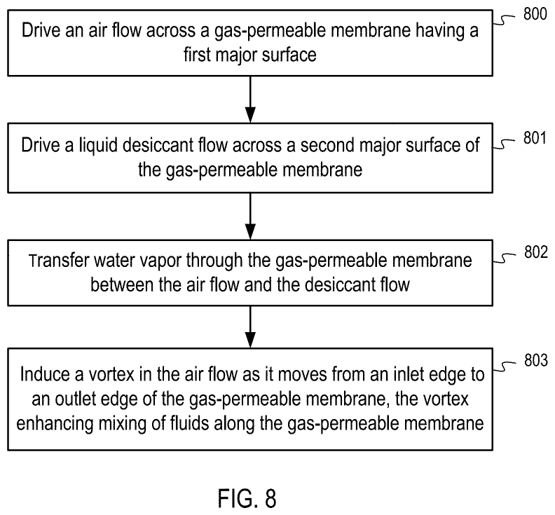

In FIG. 8, a flowchart shows a method according to an example embodiment. the method involves driving 800 an air/gas flow across a gas-permeable membrane having a first major surface. A liquid desiccant flow is driven 801 across a second major surface of the gas-permeable membrane. Water vapor is transferred 802 through the gas-permeable membrane between the air/gas flow and the desiccant flow. A vortex is induced 803 in the air/gas flow as it moves from an inlet edge to an outlet edge of the gas-permeable membrane. The vortex increases a transfer of the water vapor through the gas-permeable membrane.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

The foregoing description has been presented for the purposes of illustration and description. It is not intended to be exhaustive or to limit the embodiments to the precise form disclosed. Many modifications and variations are possible in light of the above teachings. Any or all features of the disclosed embodiments can be applied individually or in any combination and are not meant to be limiting, but purely illustrative. It is intended that the scope of the invention be limited not with this detailed description, but rather, determined by the claims appended hereto.

1. A membrane assembly for an energy and vapor exchanger, comprising:
a gas-permeable membrane having a first major surface that faces a gas flow and a second major surface that faces a liquid desiccant flow; and
an inlet region proximate an inlet edge of the gas-permeable membrane, the inlet region comprising a vortex generator that creates a vortex in the gas flow as it moves from the inlet edge to an outlet edge of the gas-permeable membrane, the vortex enhancing mixing of fluids along the gas-permeable membrane and convectively replacing gas that has dried out near the gas-permeable membrane with wetter gas from the gas flow.

2. The membrane assembly of claim 1, wherein the gas-permeable membrane comprises a sheet that forms a first side of a gas flow path through which the gas flow moves, a plate facing the sheet forming a second side of the gas flow path.

3. The membrane assembly of claim 2, wherein the vortex generator is located away from the sheet and the plate.

4. The membrane assembly of claim 2, wherein the inlet region comprises a planar structure parallel to and aligned with the gas-permeable membrane, the vortex generator protruding from the planar structure.

5. The membrane assembly of claim 2, wherein the vortex generator comprises a three-dimensional polygonal structure protruding from the inlet region.

6. The membrane assembly of claim 1, wherein the gas-permeable membrane comprises a tube, an inner surface of the tube forming a gas flow path through which the gas flow moves.

7. The membrane assembly of claim 1, wherein the gas-permeable membrane comprises a tube, an outer surface of the tube being exposed in an gas flow path through which the gas flow moves.

8. The membrane assembly of claim 1, wherein the vortex generator creates two counter-rotating vortex pairs in the gas flow.

9. The membrane assembly of claim 1, wherein the gas-permeable membrane is hydrophobic.

10. The membrane assembly of claim 9, wherein the gas-permeable membrane comprises expanded polytetrafluoroethylene.

11. The membrane assembly of claim 10, wherein the expanded polytetrafluoroethylene is bonded to a non-porous, plastic support.

12. The membrane assembly of claim 1, wherein the liquid desiccant flow comprises a lithium salt solution.

13. A gas-to-liquid vapor exchanger, comprising:
a gas flow path comprising a gas-permeable membrane having a first major surface that faces a gas flow;
a fluid flow path formed at least in part by a second major surface of the gas-permeable membrane, a liquid desiccant moving through the flow path, the gas-permeable membrane transferring water vapor between the gas flow path and the fluid flow path; and
an inlet region of the gas flow path comprising a vortex generator that creates a vortex in the gas flow as it moves from the inlet to an outlet of the gas flow path, the vortex increasing a transfer of the water vapor through the gas-permeable membrane.

14. The gas-to-liquid vapor exchanger of claim 13, wherein the gas-permeable membrane comprises a sheet that forms a first side of the gas flow path, a plate facing the sheet forming a second side of the gas flow path, wherein the vortex generator is located away from the sheet and the plate.

15. The gas-to-liquid vapor exchanger of claim 14, wherein the inlet region comprises a planar structure parallel to and aligned with the gas-permeable membrane, the vortex generator protruding from the planar structure.

16. The gas-to-liquid vapor exchanger of claim 14, wherein the gas flow in the gas flow path has a laminar Reynolds number.

17. The gas-to-liquid vapor exchanger of claim 13, wherein the vortex generator creates two counter-rotating vortex pairs.

18. The gas-to-liquid vapor exchanger of claim 13, wherein the gas-permeable membrane comprises expanded polytetrafluoroethylene.

19. The gas-to-liquid vapor exchanger of claim 18, wherein the expanded polytetrafluoroethylene is bonded to a polypropylene support.

20. A method comprising:
driving a gas flow across a gas-permeable membrane having a first major surface;
driving a liquid desiccant flow across a second major surface of the gas-permeable membrane;
transferring water vapor through the gas-permeable membrane between the gas flow and the desiccant flow; and
inducing a vortex in the gas flow via a vortex generator as the gas flow moves from an inlet edge to an outlet edge of the gas-permeable membrane, the vortex enhancing mixing of fluids along the gas-permeable membrane.
